(19) United States
(12) Patent Application Publication
(10) Pub. No.: US 2011/0235488 A1
(43) Pub. Date: Sep. 29, 2011

(54) Super-Resolution Optical Disc Reader and Read Method Optimized Through Amplitude Measurement

(75) Inventors: Fabien Laulagnet, Fontaine (FR); Marie-Françoise Armand, Vaulnaveys Le Haut (FR); Alain Fargeix, Montbonnot Saint Martin (FR); Bérangère Hyot, Eybens (FR)

(73) Assignee: COMMISSARIAT A L'ENERGIE ATOMIQUE, Paris (FR)

(21) Appl. No.: 12/890,085

(22) Filed: Sep. 24, 2010

(30) Foreign Application Priority Data
Sep. 29, 2009 (FR) 09 04640

(51) Int. Cl. G11B 7/125

(52) U.S. Cl. 369/53.26; G9B/7.099

(57) ABSTRACT

The invention relates to the field of the optical recording of information on a medium, such as an optical disc. To read an optical disc in super-resolution mode, a procedure for optimizing the power of the read laser beam is implemented. This optimization is based on the observation that a correlation exists between the power allowing the disc to be read without risk in super-resolution mode and the amplitude of the read signal which results from the reading of marks having the smallest possible dimension (marks 2 T). The amplitude of the optical disc is measured for several powers of decreasing values of the read laser, the reduction in amplitude is observed. A read power is selected as a function of the power for which a decrease (for example 5%) is noted in the amplitude measured at the start.

### CROSS-REFERENCE TO RELATED APPLICATION

This application claims priority to foreign French patent application No. FR 0904640, filed on Sep. 29, 2009, the disclosure of which is incorporated by reference in its entirety.

### FIELD OF THE INVENTION

The invention relates to the field of the optical recording of information on a medium, such as an optical disc.

### BACKGROUND OF THE INVENTION

The invention relates to the field of the optical recording of information on a medium, such as an optical disc.

The information is in principle stored on the medium in the form of physical marks that are singularities of controlled dimensions that provide an optical contrast enabling them to be read by a laser beam detection system.

The physical marks may be impressions formed by moulding of a polycarbonate substrate (for example for a DVD-ROM device)—they are then recorded once and for all. They may also be formed by zones recorded in sensitive layers through the action of a write light beam—the recording may then be reversible (possible erasure or even re-recording) or may be irreversible (no possible erasure or rewriting).

When seeking to increase the density of information recorded on an optical disc, the limitation is in general the performance of the information read device. The basic principle is that physical information written in the disc cannot be read if their size is smaller in size than the resolution limit of the optical system that will be used to read this information. Typically, with reading using a red laser of 650 nm wavelength and a numerical aperture of 0.6, it cannot normally be hoped for information smaller in size than 0.3 microns to be correctly read.

However, methods referred to as super-resolution methods have been devised for reading information having a physical size smaller than the optical resolution limit (LR=(λ/4).NA) where λ is the resolution and NA the numerical aperture of the focussing optic of the laser. These methods are based on the non-linear optical properties of certain materials. The “non-linear properties” is understood to mean that certain optical properties of the material change with the intensity of the light that they receive. The read laser itself will locally modify the optical properties of the material through thermal, optical, thermooptical and/or optoelectronic effects over smaller lengths than the size of the read laser spot. Because of the change in property, information present in this very small volume becomes detectable, whereas it would not be detectable without this change.

The phenomenon exploited is based mainly on two properties of the read laser that will be used:
firstly, the laser is focused very strongly so as to have an extremely small section (of the order of the wavelength), but the power distribution of which is gaussian, being very strong at the centre but highly attenuated on the periphery; and
secondly, a read laser power is chosen such that the power density over a small portion of the section, at the centre of the beam, significantly modifies an optical property of the layer, whereas the power density outside this small portion of the section does not significantly modify this optical property, the optical property being modified in a direction aimed at reading information that would not be able to be read without this modification.

For example, in the case of super-resolution discs, the reflectivity is locally increased over a zone smaller than the diameter of the laser beam. It is this modification due to the non-linear optical properties that will allow smaller marks, which are not normally detectable, to be read.

In a prior patent application, filed in France under the number FR 07/00938 on 9 Feb. 2007 (publication FR 2912539), an optical storage structure operating in super-resolution mode was proposed. This structure comprises a substrate (preferably made of polycarbonate) provided with physical marks, the geometric configuration of which defines the recorded information, a superposition of three layers above the marks of the substrate, and a transparent protective layer above this superposition, the superposition comprising an indium antimonide or gallium antimonide layer inserted between two dielectric layers of a zinc sulphide-silicon oxide (ZnS—SiO₂) compound.

This structure is favourable because it requires a relatively low read laser power to read the information in super-resolution mode with a satisfactory signal/noise ratio. Now, the question of the read power is critical since, on the one hand, a high enough power is necessary to obtain a super-resolution effect by locally changing the optical properties, but, on the other hand, too high a power has a tendency for the recorded information to be gradually destroyed, limiting the number of possible read cycles, whereas it is desirable to have as large a number of read cycles as possible.

By carrying out trials on these structures based on InSb or GaSb between two ZnS—SiO₂ layers, it has however been found that the choice of read power is not simple, in that super-resolution readout is not possible with too low a power, while excessively high power is unnecessary or threatens the preservation of the information or even of the optical medium, and it seems that there is an intermediate power zone, below the optimum power that allows super-resolution readout, for which the stored information is irremediably degraded by the read laser.

This observation was made based on repeated measurements on specimens having uniformly distributed marks recorded in super-resolution.

It is therefore desirable to provide an optical information read system having means for optimizing the read laser power while taking into account this risk of irreversible degradation of the information for intermediate power levels below this optimum power.

Moreover, the standards for recording information in optical discs require the marks to have standardized lengths that are expressed in multiples of a base dimension T that corresponds to the width of the marks, the smallest marks having a length 2 T and the largest a length 9 T. The marks of length 2 T cannot be read without applying the super-resolution mode, that is to say they are not visible by means of a laser beam which (at the same wavelength) would not have, at the centre of the beam, a power density sufficient for the properties of the sensitive layer to be significantly modified.

According to the invention, the signals resulting from reading a series of marks, the dimensions of which are below the resolution limit, are used (it is not essential to use the smallest mark on which there would be less precision than on a larger mark, but still lying beneath the optical resolution limit) with several different power levels, to determine a curve of variation of amplitude, to deduce therefrom a read power that enables the marks to be reliably read in super-resolution mode and then to apply this read power to the laser, so as to read the information on the optical disc.

### SUMMARY OF THE INVENTION

The invention provides an optical disc reader operating in super-resolution mode and comprising a read laser, suitable for reading optical discs having a structure comprising a substrate provided with physical marks, the geometrical configuration of which defines the recorded information, a superposition of three layers above the marks of the substrate, and a transparent protective layer above this superposition, the superposition comprising an indium antimonide or gallium antimonide layer inserted between two dielectric layers of a zinc sulphide-silicon oxide compound (ZnS—SiO₂), the reader being characterized in that it comprises means for varying the power of the read laser, means for measuring an amplitude of the signal for reading recorded marks having the smallest possible size for super-resolution readout, for several decreasing power levels of the read laser starting from a predetermined maximum value, means for determining a read power Pa for which the amplitude drops below a value k1.A0, where A0 is the amplitude of the first measured power level or the average amplitude of the first measured power levels, and k1 is a coefficient which is less than 1, and preferably between 0.85 and 0.95, means for stopping the measurements for this power Pa and means for applying a read power PL for subsequently reading the information present on the disc, where PL is equal to k.Pa, k being a coefficient greater than or equal to 1.

The measured amplitude must be considered here as a relative variation in the signal level between a mark (minimum amplitude) and an absence of a mark (maximum amplitude). Thus, it is the alternations of marks and absences of marks that generate a signal having an amplitude, and this amplitude is independent of the power when the marks are correctly read in super-resolution mode. The measured amplitude is a peak-to-peak (min-max) amplitude.

Preferably, the amplitude measurement is carried out in a dedicated zone of the optical disc, this zone containing no useful information other than what is necessary for the measurement, namely series of marks 2T (smallest marks that can be read in super-resolution mode); the amplitude measurements and the selection of a read power preferably being repeated at each new insertion of a disc into the reader.

### BRIEF DESCRIPTION OF DRAWINGS

Other features and advantages of the invention will become apparent on reading the following detailed description given with reference to the appended drawings in which:

FIG. 1 shows an example of the structure of an optical disc;

FIG. 2 shows a view, using an atomic force microscope, of a substrate in which marks having a minimum length of 80 nanometres and spaced apart by a minimum of 80 nanometres have been preformed; and

FIG. 3 shows a measured amplitude curve of this structure as a function of the power of the read laser, for reading marks of small dimension 2 T.

### DETAILED DESCRIPTION

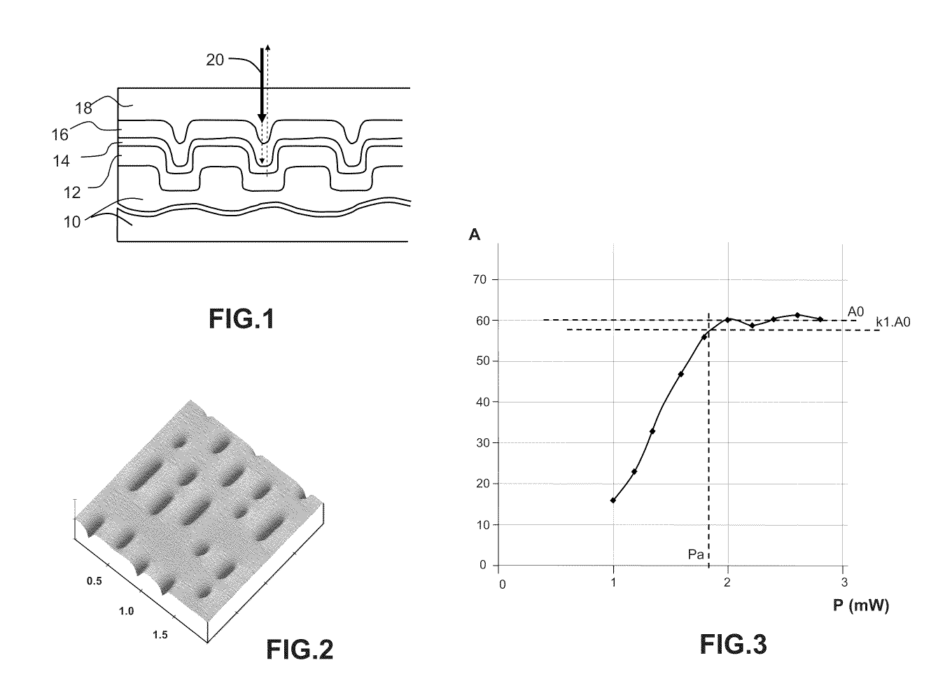

FIG. 1 shows the general structure of an optical disc that can be read in super-resolution mode. It comprises a substrate 10 which is preferably made of an organic material, and notably of polycarbonate conventionally used for optical discs. Information is conventionally written into the disc on approximately concentric tracks, a read laser beam, shown symbolically by the arrow 20, placed in front of the disc, seeing the information running past it as the disc rotates.

The substrate 10 contains physical marks defining the recorded information, and in this example the physical marks are in the form of a relief imprinted on the upper surface of the substrate. For example, the relief consists of pits, the width of which is approximately constant for all the written information, but the length and the spacing of which, in the run direction of the information, define the content of the information written thereon. The information is read by analysing the phase of the laser beam reflected by the structure, which phase varies at the start and at the end of the passage of each physical mark. The pits may be pre-recorded by pressing the polycarbonate or the plastic substrate, for example using a nickel mould that has been produced using very high-resolution electron-beam etching tools.

The width, length and spacing of the physical marks may be below the theoretical optical resolution of the optical read system that will serve for reading them. Typically, this is a blue laser about 400 nanometre wavelength, used with a focusing optic having a numerical aperture of 0.85, the theoretical physical resolution limit being around 120 nanometers when taking precautions. Here, the marks may be pre-recorded with a resolution, in terms of length or spacing, of less than 80 nanometers. FIG. 2 shows a schematic view of the recessed physical marks recorded in this way on a disc.

In the case of a conventional optical disc, the relief (pits or bumps) would be covered with a simple layer of aluminium, but this aluminium layer would not allow a blue laser to detect marks with a length and spacing equal to 80 nanometres.

To allow such detection, the marks are covered with a sensitive structure allowing super-resolution detection. The structure comprises three layers consisting, in the following order, of a dielectric layer 12 of ZnS—SiO₂ compound, an indium antimonide (InSb) or gallium antimonide (GaSb) layer 14 and a dielectric layer 16 of ZnS—SiO₂ compound. The three-layer assembly is covered with a transparent protective layer 18. The InSb or GaSb layer 14 is a layer having non-linear optical properties.

Such a disc may be read by a reader comprising a blue laser emitting a beam with a power of about 1 to 3 milliwatts (corresponding in practice to a power density of about 7 milliwatts per square micron).

However, the sensitive structure is fragile and it has been found that the written information could be degraded for certain power level ranges, either power levels that are too high or even those below the necessary power for being able to read in super-resolution mode. It is therefore necessary to try to stop the read laser emitting at a power level causing a risk of degradation. The disc reader manufacturer will in principle provide for the laser to operate at a power that minimises the risks. The power will therefore be calibrated according to the disc manufacturer's specification or standards relating to such discs, when they exist.

However, such a calibration does not optimize the choice of power level if there may be variations in the optimum power depending on the manufacturer or on the industrial fabrication process, or even depending on the series manufactured by the same manufacturer and by the same process.

By carrying out experiments on sensitive structures allowing super-resolution operation, it has been found that there is a certain type of relationship between the amplitude of the signal for reading the smallest size marks of the sensitive layer and the power emitted by the read laser; the amplitude is approximately constant provided that the laser has a power that allows operation in super-resolution mode, but the amplitude decreases if the power decreases. When the power has greatly decreased, it is known that the laser no longer operates at all in super-resolution mode. When it has decreased only slightly, it is known that operation in super-resolution mode is possible but it has been found that the operation is at risk in that power levels that are too close to the threshold for transition to super-resolution mode tend to irreversibly degrade the information contained in the disc.

This is why the aim of the invention is to avoid this transition zone.

FIG. 3 shows a curve of the amplitude of the read signal delivered by the read head of the disc reader as a function of the power of the laser beam emitted. The power is in milliwatts and the amplitude is in arbitrary units; the laser beam emits at a wavelength of 405 nanometres; the signal is that which results from reading marks having the smallest possible size 2 T according to the recording standard of the optical disc in question. For the sensitive layer that corresponds to this curve, super-resolution readout is possible above a power level of about 1.5 milliwatts, whereas below this power level these 2 T marks can only be read with difficulty because of the absence of the super-resolution effect.

However, it is observed that the transition zone in which the amplitude increases with power is a zone at risk: it corresponds to power levels that allow super-resolution readout to some extent, but with the risk of degrading the information. It is considered that the zone at risk is located between about 1.2 milliwatts and 1.7 milliwatts.

According to the invention, the disc reader is provided with means for measuring the amplitude of the read signal generated by 2 T marks, for several possible power levels, and means for deducing, from these measurements, a read power to be applied subsequently for reading the useful information on the disc.

The preferred method consists in measuring the amplitude of the read signal for decreasing read power levels starting from a predetermined maximum level. The maximum level is for example 3 watts for an optical disc having a response curve of the kind shown in FIG. 3.

Once the amplitude of the signal starts to drop significantly, for example by 5%, the power level is considered to come into the zone at risk.

If the amplitude of the first readout (or alternatively the average of the amplitudes of the first readouts, for example 3 or 4 first readouts) is A0, then the power level for which it is found that the detected amplitude is equal to k1.A0 is denoted by Pa.

A power PL=k.Pa, k preferably being greater than 1, is selected as laser read power for reading the useful information stored in the disc. For example, k is between 1 and 1.2.

In the example of the curve shown in FIG. 3, with k1=0.95, a power Pa of about 1.8 mW is found and a read power of 1.8 mW may be selected if k is chosen to be equal to 1 or 2.1 mW if k is selected to be equal to 1.1

Carrying out an amplitude measurement for decreasing power levels, and therefore a priori outside the risk zone, avoids applying a power that would degrade the material of the sensitive layer in the zone where the 2 T marks used for this measurement are registered.

Experimental measurements on commercially available sensitive layer structures would make it possible to known what value of k would ensure a level of safety sufficient to take into account the disc manufacturing dispersion. Too small a value of k would run the risk of giving a read power not sufficiently outside the degradation zone. Too high a value of k would give an excessive read power in relation to the requirements for reading in super-resolution mode.

The determination of the power at which the first measurement will be carried out is based on the nominal indications given by the disc manufacturer. For example, a power level 30% higher than the nominal power for super-resolution readout indicated by the manufacturer will be taken.

The tests are carried out in an optical disc zone reserved for this purpose, containing no useful information but having physical marks of dimension 2 T. The measurements are made with the disc rotating at a speed that corresponds to the normalized linear speed (typically a speed giving a data rate of 66 Mbits/second). If the disc has to be read at a higher speed, a test has to be carried out at a higher speed, since the optimum power depends on the speed at which the marks run under the laser beam. More generally, a test at several speeds is recommended.

For example, the test should be carried out at each new insertion of an optical disc into the reader.

1. An optical disc reader operating in super-resolution mode and comprising a read laser, suitable for reading optical discs having a structure comprising a substrate provided with physical marks, the geometrical configuration of which defines the recorded information, a superposition of three layers above the marks of the substrate, and a transparent protective layer above this superposition, the superposition comprising an indium antimonide or gallium antimonide layer inserted between two dielectric layers of a zinc sulphide-silicon oxide (ZnS—SiO₂) compound,
the reader further comprising means for varying the power of the read laser, means for measuring an amplitude of the signal for reading recorded marks having the smallest possible size for super-resolution readout, for several decreasing power levels of the read laser starting from a predetermined maximum value, means for determining a read power Pa for which the amplitude drops below a value k1.A0, where A0 is the amplitude of the first measured power level or the average amplitude of the first measured power levels, and k1 is a coefficient which is less than 1 and preferably between 0.85 and 0.95, means for stopping the measurements for this power Pa and means for applying a read power PL for subsequently reading the information present on the disc, where PL is equal to k.Pa, k being a coefficient greater than or equal to 1.

2. The disc reader according to claim 1, wherein the means for measuring the signal amplitude are designed to take the measurement in a dedicated zone of a disc read by the reader, this zone containing no useful information other than that intended to be measured.

3. The disc reader according to claim 2, wherein the measuring means, the means for determining the desirable power and the means for applying this power to the read laser are designed to measure, determine and apply the determined power at each new insertion of a disc into the reader.

4. The disc reader according to claim 1, wherein the measuring means, the means for determining the desirable power and the means for applying this power to the read laser are designed to measure, determine and apply the determined power at each new insertion of a disc into the reader.

5. A method of reading an optical disc by means of a read laser operating in super-resolution mode, suitable for reading optical discs having a structure comprising a substrate provided with physical marks, the geometrical configuration of which defines the recorded information, a superposition of three layers above the marks of the substrate, and a transparent protective layer above this superposition, the superposition comprising an indium antimonide or gallium antimonide layer inserted between two dielectric layers of a zinc sulphide-silicon oxide compound wherein the amplitude of the signals resulting from reading a series of marks having the smallest possible size is measured for several different power levels on the basis of a predetermined maximum power level, a curve of amplitude variation and a read power Pa for which the amplitude drops below a value k1.A0 are determined, where A0 is the amplitude of the first measured power level or the average amplitude of the first measured power levels and k1 is a coefficient which is less than 1 and is preferably between 0.85 and 0.95, the measurements are stopped for this power Pa and then, to read the information on the optical disc, a read power PL equal to k.Pa, k being a coefficient greater than or equal to 1, is applied to the laser.

6. The read method according to claim 5, wherein the amplitude measurement is carried out in a dedicated zone of the optical disc, this zone containing no useful information other than series of marks of the smallest dimension that can be read in super-resolution mode.

7. The read method according to claim 6, wherein the amplitude measurements and the selection of a read power are repeated at each new insertion of a disc into the reader.

8. The read method according to claim 5, wherein the amplitude measurements and the selection of a read power are repeated at each new insertion of a disc into the reader.
